(19) United States
(12) Patent Application Publication
(10) Pub. No.: US 2009/0000095 A1
(43) Pub. Date: Jan. 1, 2009

(54) SPIRAL SPRING RETENTION WRENCH

(76) Inventor: Stephen Blok, Pembroke (CA)

Correspondence Address: NIKOLAI & MERSEREAU, P.A., 900 SECOND AVENUE SOUTH, SUITE 820, MINNEAPOLIS, MN, 55402, US

(21) Appl. No.: 12/147,627

(22) Filed: Jun. 27, 2008

(30) Foreign Application Priority Data
Jun. 28, 2007 (CA) 2592822

(51) Int. Cl. B23P 19/04

(52) U.S. Cl. 29/227

(57) ABSTRACT

A spiral spring retention wrench for removing a cable-retaining bolt from a sliding throttle valve of a carburetor. The wrench comprises a disk-like body having two, flat, opposed surfaces and a circumscribing peripheral edge extending between the surfaces. A depression, having a circular periphery is centered on one surface of the body. The diameter of the depression is such as to receive an end of the spring and hold that end during use of the wrench to remove the bolt. On the other surface of the body a centrally disposed depression for receiving a head of the cable retaining bolt in a manner so as to grip the bolt head and act on it either to release or tighten the bolt when the wrench is rotated.

### FIELD OF THE INVENTION

The present invention relates to a spiral spring retention wrench for removing a cable retaining bolt from a sliding throttle valve of a carburetor.

### BACKGROUND OF THE INVENTION

Sliding throttle valves are conventionally used in controlling the gasoline/air intake to single or dual cylinder internal combustion engines, for instance used on motorcycles, snowmobiles and the like. A throttle cable, controlled by the vehicle operator, adjusts the level of the sliding throttle valve at the engine intake port. Adjustably associated with a lower portion of the sliding throttle valve is a tapered needle which is slidably seated in a needle jet, which jet communicates with the fuel reservoir and meters fuel into the engine intake port, fuel flow being controlled by the positioning of the needle in the needle jet through the sliding throttle valve. At its upper end, the sliding throttle valve is tensioned by a spiral spring. For servicing the sliding throttle valve, or adjusting the position of the needle, a cable retaining bolt, threaded into the throttle valve on the spring side thereof must be removed. To do so is a difficult task, usually requiring two persons, one to lift the coil spring away from its position bearing against an upper end of the sliding throttle valve, and the other person, using a wrench or set of pliers, while holding the throttle valve, unscrewing the cable retaining bolt. Similarly, when reattaching the cable retaining bolt to the sliding throttle valve, two persons are conventionally required, one to again hold the spring away from the sliding throttle valve, and the other to thread the bolt back into the sliding throttle valve.

It is an object of the present invention to provide a tool which will simplify the removal of the cable retaining bolt from the sliding throttle valve, and its reattachment thereto.

### SUMMARY OF THE INVENTION

In accordance with the present invention there is provided a spiral spring retention wrench for removing a cable-retaining bolt from a sliding throttle valve of a carburetor. The wrench comprises a disk-like body having two, flat, opposed surfaces and a circumscribing peripheral edge extending between the surfaces. A depression, having a circular periphery is centered on one surface of the body. The diameter of the depression is such as to receive an end of the spring and hold that end during use of the wrench to remove the bolt. On the other surface of the body is a centrally disposed depression for receiving a head of the cable retaining bolt in a manner so as to grip the bolt head and act on it either to release or tighten the bolt when the wrench is rotated.

In one embodiment, the wrench includes a linear slot of sufficient width to receive a throttle cable while the cable is secured to the bolt. The slot extends from an opening at the edge to a central location on the body. On the other surface of the body, a depression extends laterally a similar distance on either side of the slot. The lateral width of this depression is sufficient to receive a head of the cable retaining bolt. This depression extends from the slot opening to the central location, where it becomes part of the centrally disposed depression and it circumscribes the slot end.

The body is preferably of circular construction and, where the slot is provided, it extends radially from the opening to the centre of the circular body. As well, a further depression is provided at the slot end, this further depression configured to seatably receive a head of a cable retaining bolt.

The tool according to the present invention, by cradling the spiral spring while the tool is rotated to either remove or, when being inserted, tighten, the table retaining bolt with respect to the sliding throttle valve, enables the task to be carried out simply and by one person.

While the invention will be described in conjunction with an illustrated embodiment, it will be understood that it is not intended to limit the invention to such embodiment. On the contrary, it is intended to cover all alternatives, modifications and equivalents as may be included within the spirit and scope of the invention as defined by the present patent specification as a whole.

### BRIEF DESCRIPTION OF THE DRAWINGS

These and other advantages of the invention will become apparent upon reading the following detailed description and upon referring to the drawings in which:

FIG. 1 is a perspective view from above of a wrench according to the present invention;

FIG. 2 is a perspective view from below of the wrench of FIG. 1;

FIGS. 3 and 4 are respectively top and bottom plan views of the wrench of FIGS. 1 and 2; and

FIGS. 5 and 6 are respectively views of the wrench similar to those of FIGS. 1 and 2, but illustrating, in phantom, a cable retaining bolt and spiral spring in position during the bolt removal or insertion process.

The present invention will now be described by way of a non-limiting description of a certain detailed embodiment.

### DETAILED DESCRIPTION OF THE DRAWINGS

In the following description, similar features in the drawings have been given identical reference numerals where appropriate. All dimensions described or suggested herein are intended solely to illustrate an embodiment. These dimensions are not intended to limit the scope of the invention that may depart from these dimensions.

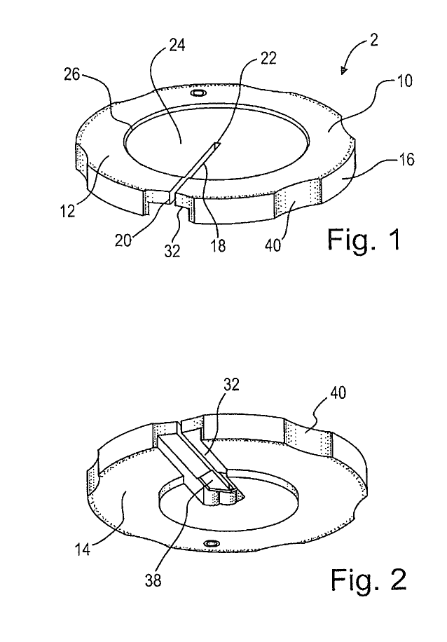

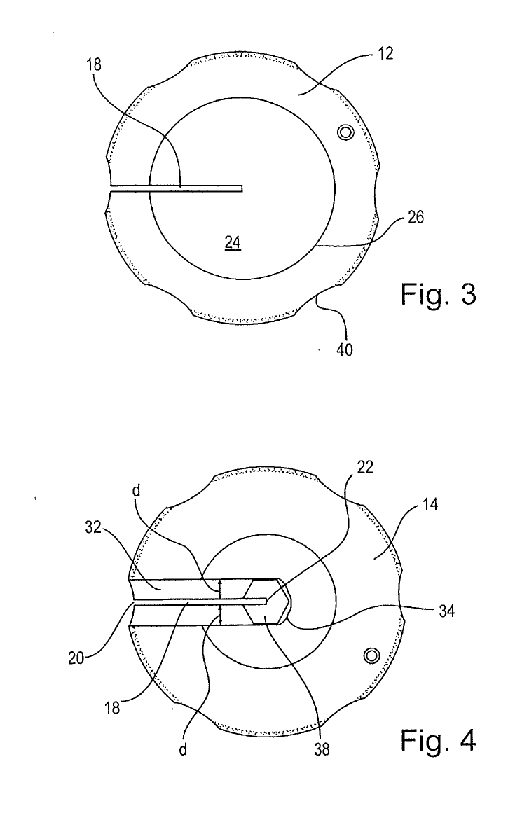

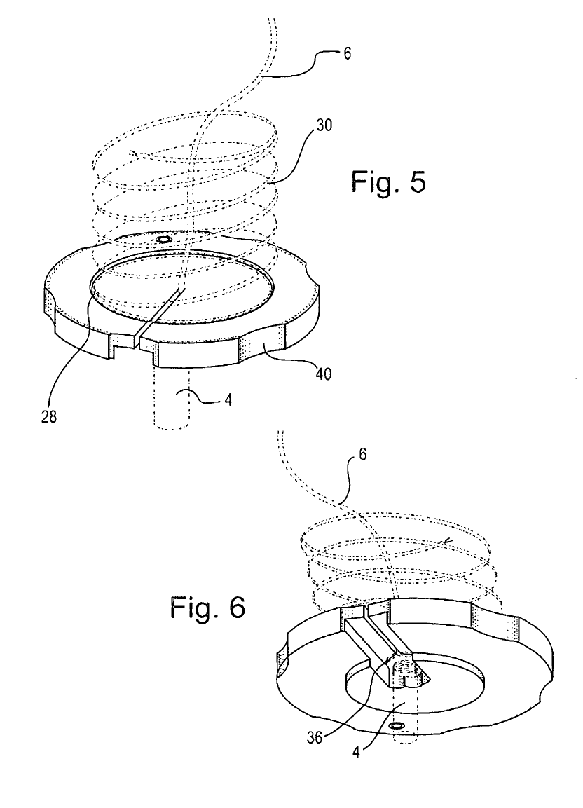

Turning to FIGS. 1 and 2, there is illustrated a spiral spring retention wrench 2 in accordance with the present invention, for removal of a cable retaining bolt 4 (phantom, FIGS. 5 and 6), or its insertion into, a sliding throttle valve (not illustrated) of a carburetor. As can be seen in phantom in FIG. 6, a throttle cable 6 is (releasably) associated with cable retaining bolt 4.

The tool 2 of FIGS. 1 and 2 has a disc-like body 10 which is preferably of generally circular configuration as illustrated, having opposed surfaces 12 and 14. Circumscribing circular peripheral edge 16 extends between surfaces 12 and 14.

A linear, cable-receiving slot 18 extends radially from peripheral opening 20 to terminate at end 22 centered in body 10. A depression 24 is provided in surface 12, this depression having a wall 26 defining a circular periphery. End 22 is in the center of circular depression 24. The diameter of this depression 24 is sufficient to receive an end 28 of coil spring 30 (FIG. 5) and hold that spring while wrench 2 is in use to remove bolt 4 from the sliding throttle valve. On the other surface 14, as can be seen in FIG. 2, there is provided a further depression 32. This depression extends laterally a similar distance on either side of slot 18. The lateral distance across the depression is sufficient to receive a head 36 of bolt 4 (FIG. 6). At end 34, depression 32 receives that head 36 and grips it for turning bolt 4, on rotation of wrench 2. This end 34 is centered with respect to the tool 2 so bolt head 36 is held in a centered location when being removed or attached using the tool. Because cable 6 is centered with respect to bolt 4 and bolt head 36, the rotational movement of wrench 2 while turning bolt 4 is not constricted, that cable essentially being seated at slot end 22.

As can be seen in FIG. 4, it is preferred that at end portion 34 of depression 32 a further depression 38 may be provided, configured to be seated tightly about nut head 36. In the illustrated embodiment, that depression 38, as well as nut head 36, have a peripheral, hexagonal configuration. Again slot end 22 is centered with respect to depression 38.

Spaced inwardly curved indentations 40 are preferably provided along edge 16, as illustrated, to facilitate gripping of wrench 2 for rotation, when in use.

In operation, to either loosen and remove a cable retaining bolt 4 from a sliding throttle valve, or to insert and tighten that bolt on the throttle valve, the user merely has to slightly compress spiral spring 30 while sliding a portion of cable 6, near the head 36 of bolt 4 into slot 18 while bolt head 36 passes along depression 32. When cable 6 has reached end 22 of slot 18, spring 30 is relaxed so that spring end 28 is seated in depression 24, wall 26 holding spring 30 in position against unpurposeful disengagement. Bolt head 36 is then seated at end 34 of depression 32, in further depression 38. Now, appropriate rotation of tool 2 and bolt 4 will either loosen or tighten that bolt. Throttle cable 6 is restrained from unintentionally sliding out of slot 18 by spring end 28.

While the wrench according to the present invention has been illustrated with a slot 18 and depression 32 in lower surface 14, it will be readily understood by those skilled in the art that tool 2 may be constructed without slot 18 or depression 32, and simply provided, on its lower surface 14, with a bolt head receiving depression 38 centrally positioned on that surface so as to grip bolt head 36 and act on it to either release or tighten the bolt when the wrench is rotated. This simpler embodiment of tool 2 may be used in situations where cable 6 is not present or does not interfere with the access of depression 38 on tool 2 to bolt head 36.

Although the present invention has been described by way of a detailed description in which various embodiments and aspects of the invention have been described, it will be seen by one skilled in the art that the full scope of this invention is not limited to the examples presented herein. The invention has a scope which is commensurate with the claims of this patent specification including any elements or aspects which would be seen to be equivalent to those set out in the accompanying claims.

1. A spiral spring retention wrench for removing a cable-retaining bolt from a sliding throttle valve of a carburetor, the wrench comprising:
a disk-like body having two, flat, opposed surfaces and a circumscribing peripheral edge extending between the surfaces,
a depression having a circular periphery centered on one surface of the body, the diameter of the depression being such as to receive an end of the spring and hold that end during use of the wrench to remove the bolt,
on the other surface of the body a centrally disposed depression for receiving a head of the cable retaining bolt in a manner so as to grip the bolt head and act on it either to release or tighten the bolt when the wrench is rotated.

2. A wrench according to claim 1 further provided with a linear slot of sufficient width to receive a throttle cable while the cable is secured to the bolt, the slot extending from an opening at the edge to a central location on the body, and, on said other surface of the body, a depression extending laterally a similar distance on either side of the slot, the lateral width of this depression being sufficient to receive a head of the cable retaining bolt, this depression extending from the slot opening to the central location where it becomes part of said centrally disposed depression and it circumscribes the slot end.

3. A wrench according to claim 1, wherein the body is of circular construction with spaced, inwardly curved indentations along that edge to facilitate turning of the wrench when in use.

4. A wrench according to claim 2, wherein the portion of the linear depression about the linear slot end is configured to be seated about, and grip for turning, a hexagonal nut head.

5. A wrench according to claim 4, wherein the depression is provided, where it circumscribes the slot end, with a further depression, this further depression configured to seatably receive, and grip for turning, a head of a cable retaining bolt.

6. A wrench according to claim 5, wherein the head receiving depression is hexagonal in shape so as to seatably receive a hexagonal bolt head.

7. A wrench according to claim 2, wherein the lateral width of the depression is constant along the slot.

8. A wrench according to claim 2, wherein the body is of circular construction and the slot extends radially from the opening to the center of the circular body.

9. A wrench according to claim 8, wherein the depression is provided with a further depression, where it circumscribes the slot end, this further depression configured to seatably receive, and grip for turning, a head of a cable retaining bolt.

10. A wrench according to claim 9, wherein the head receiving depression is hexagonal in shape so as to seatably receive a hexagonal bolt head.
